(19) United States
(12) Patent Application Publication
(10) Pub. No.: US 2024/0150938 A1
(43) Pub. Date: May 9, 2024

(54) ACTIVE COLOR-CHANGING LIQUID CRYSTAL FILAMENT AND YARN

(71) Applicant: BOARD OF TRUSTEES OF THE UNIVERSITY OF MAINE SYSTEM, Orono, MN (US)

(72) Inventors: Christopher ERB, Readfield, MN (US); David F. ERB, Jr., Readfield, MN (US)

(73) Assignee: BOARD OF TRUSTEES OF THE UNIVERSITY OF MAINE SYSTEM, Orono, MN (US)

(21) Appl. No.: 18/279,280

(22) PCT Filed: Mar. 15, 2022
(86) PCT No.: PCT/US2022/020345

§ 371 Date: Aug. 29, 2023

Related U.S. Application Data
(60) Provisional application No. 63/161,546, filed on Mar. 16, 2021.

(51) Int. Cl. D01D 11/06; C09K 19/02; D01F 8/10

(52) U.S. Cl. CPC D01D 11/06; C09K 19/02; D01F 8/10; C09K 2219/03; C09K 2323/06

(57) ABSTRACT

A color-changing filament or yarn is provided that delivers fully-controllable full-spectrum response to current input. In embodiments, the filament is adapted to be woven into a textile and controlled to vary and maintain color independently of external temperature.

### CROSS REFERENCE TO RELATED APPLICATIONS

This application claims the benefit of U.S. Provisional Application No. 63/161,546, filed Mar. 16, 2021, which is incorporated herein by reference in its entirety.

### FIELD OF THE INVENTION

Embodiments of the invention relate to a fully-controllable, full-spectrum, color-changing weavable filament, wherein each filament or yarn comprises an active element adapted to be connected to a source of electric current to cause a liquid crystal material coated thereon to achieve a desired full-spectrum color change.

### BACKGROUND OF THE INVENTION

Liquid crystals are characterized by their hydrodynamic ability to flow freely while exhibiting anisotropic and crystalline properties—to behave as solid crystalline phases, liquid phases, and in intermediate phases where they behave as both phases simultaneously. Thus, liquid crystals are described as mesogenic, existing in a number of different phases, termed mesophases, including nematic, cholesteric, smectic, and ferroelectric mesophases.

Nematic liquid crystals are historically the most studied liquid crystal mesophase. The nematic liquid crystal mesophase gets its name from the Greek word nema, meaning “thread.” A sample of nematic liquid crystal aligned along a director axis may be considered a single crystal. An important sub-classification of nematic liquid crystals is that of chiral nematic liquid crystals. Chiral nematic liquid crystals—sometimes referred to as cholesterics—tend to align in a helical manner as a result of chiral moieties attached to the nematic liquid crystal molecular structure. Of particular interest is the ability of these materials to change color in response to a temperature change.

Liquid crystals have been widely utilized commercially, beginning with early liquid crystal displays of the 1960s to the full color spectrum active-matrix liquid crystal displays of the present day. These materials have become dominant in the field of small screen electronic displays, and even large screen displays.

U.S. Pat. No. 4,642,250 describes fabric articles coated with liquid crystals which change color according to the body temperature of the wearer. However, individual threads of the fabric are not electrically active to effect thermochromic change, nor is a filament or yarn of the material coated in liquid crystal.

U.S. Patent Application Publication No. 2019/0112733 A1 teaches a fiber spinning system using a polymeric matrix to incorporate a color changing pigment in a monofilament. However, liquid crystal, to the extent it is mentioned, is considered as a component in a melt spun polymeric matrix. No techniques are taught for providing a black background on a monofilament, or that would otherwise enable a conductive filament to be coated with a full spectrum color changing liquid crystal layer.

The above referenced patent and patent application publication are incorporated by reference for their teaching of the state of the art as well as for background technical knowledge which would be known to the person of ordinary skill in the art.

### SUMMARY OF THE INVENTION

In embodiments, the invention includes methods for making a color-changing filament, comprising: providing a liquid black backing coating composition to a free meniscus coating apparatus, and drawing a flexible resistive conductive filament through the coating apparatus to coat the resistive conductive filament with at least one layer of the black backing composition; providing a liquid crystal composition with a predetermined viscosity to the free meniscus coating apparatus; drawing the conductive filament coated with the black backing composition through the coating apparatus to coat the filament with the black backing composition thereon with at least one liquid crystal layer to form a liquid crystal coated filament; coating the liquid crystal coated filament with a transparent protective polymer to form a color changing filament; and collecting the color changing filament on a spool.

In embodiments, the invention is a color-changing filament (or grouping of continuous filaments to form a yarn), which may be made according to the above method, comprising: a resistive conductive filament adapted to be connected to a source of electric current; a black backing layer coated on the conductive filament; a chiral-nematic liquid crystal layer coated on the black backing layer; and a transparent protective layer coated on the liquid crystal layer.

In embodiments, a color-changing device incorporates the color-changing yarn, and comprises: a source of electric current (for example, a battery) a woven fabric comprising a color-changing yarn operatively connected to the source of electric current, the yarn comprising a resistive conductive filament; a black backing layer coated on the conductive filament; a chiral-nematic liquid crystal layer coated on the black backing layer; and a transparent protective layer coated on the liquid crystal layer; and a controller operatively connected to the source of electric current, to control the temperature of the yarn within specified limits (using a temperature of the yarn as a control feedback, for example).

### BRIEF DESCRIPTION OF THE DRAWINGS

Aspects of the invention described herein are depicted in the attached drawings.

FIG. 1 is a schematic view of a color-changing filament according to embodiments of the invention.

FIG. 2 is a schematic view of a two-stage free meniscus filament coating line according to embodiments of the invention.

FIG. 3 schematically depicts a polymer overcoating apparatus according to embodiments of the invention.

FIG. 4 schematically depicts a textile swatch according to embodiments of the invention.

### DETAILED DESCRIPTION OF THE INVENTION

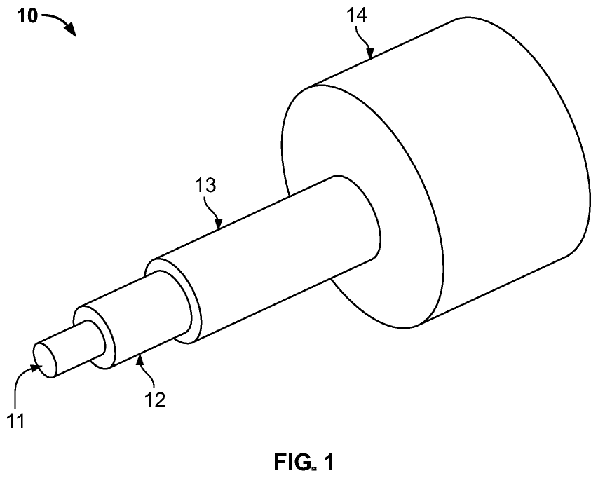

As shown schematically in FIG. 1, a color-changing filament 10 according to the invention comprises at least a conductive core 11, a black backing layer 12 which renders the color change of the liquid crystal visible, a chiral nematic liquid crystal material 13, and a transparent protective layer 14 on the liquid crystal. In embodiments, the filament is able to be provided on a spool and processed using conventional textile processing. The filament typically has a thickness in a range of 0.001 inch (25.4 micron) to 0.05 inch (1.27 mm) and may be as fine as a few 10s of microns, for example, as fine as 30 um, limited by the requirement that the conductive core may be able to carry a current and support a temperature change in the desired range. As a practical matter, a conductive core typically has a diameter of about 10 μm or greater. Minimum thicknesses for a black backing layer may be as low as a few microns up to about 100 microns, while it may be possible to coat a layer of liquid crystal as thin as 10-20 μm using a free meniscus coating system up to about 100 microns or more. In embodiments, the completed filament may have a thickness of 50-1000 μm, and in embodiments 50-500 μm to allow for conventional textile processing. However, these are merely guidelines and are not critical to the invention. In practice, the fineness of an individual filament may be driven by the equipment used for the coatings and a particular end-use application. Liquid crystal is a relatively expensive material, which dictates a practical upper limit of the thickness of the layer.

In embodiments, a yarn incorporates multiple filaments twisted or spun into a yarn to provide a robust conductor. Thus, the color-changing element that may be made into a fabric according to embodiments of the invention may be a filament or a “yarn” comprising a plurality of monofilaments. In any case, the monofilament is capable of supporting a black backing layer and liquid crystal layer as described herein. It is contemplated that conductive filaments may be twisted into conductive yarn for the purposes of the invention and may incorporate nonconductive materials. In embodiments, multiple coated filaments or yarns may be twisted together to make a functional redundant system whereby failure of adjacent yarns would be compensated by other working filaments in the bundle.

The conductive core of the filament serves as a substrate and a source of current for the liquid crystal color-changing material, and accordingly may be any flexible material that conducts electricity and heats resistively. Suitable resistive materials such as nichrome wire are made for that purpose. However, embodiment described herein successfully employed 38-gauge (0.004 inch; 101.6 micron) copper wire and similarly sized stainless steel wire. In principle, any thin conductive metal wire or carbon fiber could be adapted for this purpose and a natural or synthetic thread with a conductive coating may be imparted with sufficient conductivity and resistivity to support liquid crystal color change with an input of current. Preferably, the conductive core is thin and flexible and can be coated using the free meniscus wire coating techniques described herein. In embodiments, the conductive core is adapted to be operatively connected to an electrical contact, using soldering, ultrasonic bonding, conductive adhesive or tape or any other equivalent means known in the art or hereafter developed for making electrical connection to a conductive element.

Liquid crystal is translucent in appearance and requires a black backing to exhibit visible color change. Suitable black coating materials for the backing layers include inks capable of being applied in layers as thin as a few microns, for example 3, 5 or 10 microns. Acrylics or other dispersions in a matrix may be employed that provide adherence of a black coating to the conductive core before applying liquid crystal—including black acrylic ink. Above certain viscosities, use of free meniscus coating techniques may be problematic. Thus, in embodiments, a liquid material having a viscosity in a range of about 1 cP and 1,000 cP (dynamic viscosity, measured using techniques known in the art) is used.

Techniques to improve the adhesion of a coating material to a conductive core or conductive coating, such as a corona treatment, may be employed inline with a free meniscus coating apparatus to achieve a black background for the liquid crystal. The black backing layer covers substantially the entire wire except where there are defects and at the ends or at areas of the filament where it is desired for the filament to be inactive and not exhibit color change. In embodiments, the conductive core material may inherently have a black color (such as carbon fiber) and may have (or may be treated to have) a surface that accepts the liquid crystal coating, in which case no separate black backing layer is required and the black backing layer may be considered integral with the conductive core.

The liquid crystal coating layer is also deposited on the conductive core having the black backing layer adhered thereon. Preferably, the black backing layer is dried before applying liquid crystal. Due to variations in surface energy, the liquid crystal layer may have a tendency to not coat uniformly. The surface tension of the black backing layer may be lowered so that beading up is lessened or eliminated. For example, viscosity modifiers such as fumed silica (sold under the tradename CABOSIL) can be added to improve coating uniformity on the black backing layer (or on the liquid crystal). With the addition of water or other solvent mixture, the viscosity of the liquid crystal coating material may be lowered to ensure the most uniform coating at the desired thickness. Corona discharge treatment and heat treatments or other treatments known in the art may be used to improve each surface for coating the subsequent layer.

An advantage of a liquid crystal color changing material, compared to a thermochromic pigment, is that full spectrum color change can be achieved with a single thin layer of liquid crystal. In this context, full spectrum refers to a filament or yarn exhibiting color change across the visible spectrum, from red to violet, which is generally understood to be in a range of about 400 nm to 750 nm, though the precise endpoints are not critical. In embodiments, a device incorporating the filament or yarn may be adapted (such as by controlling the current applied) to operate over only a portion of the visible spectrum.

In embodiments, the liquid crystal materials are preferably chiral nematic (also called cholesteric) thermochromic materials, meaning that they change color in response to a change in their temperature. Temperature bandwidth of the liquid crystal refers to the temperature change required to change between the primary colors. This temperature bandwidth is modified by varying the concentration of liquid crystal in the coating solution. In embodiments, a concentration of liquid crystal in the coating solution can be manipulated so that a change between primary colors occurs with a temperature change of Δ1° C. up to about Δ20° C. For example, a temperature change of 1° C. may bring about a change from red to yellow for one liquid crystal material, but coated at a different concentration, a temperature change of 20° C. may be required to effect the same change. The precise parameters are typically known to and available from suppliers of such materials. Depending on the requirements of the application, a liquid crystal coating solution may also be modified to change between primary colors with a temperature change of Δ2° C., Δ5° C., Δ10° C. or other intermediate value.

Liquid crystal color change is generally operable at about −30° C. (the lowest temperature at which red is obtained) up to about 120° C., at which temperature the liquid crystal begins to degrade. “About” is used as a modifier because the exact endpoint temperatures not been conclusively determined by the inventors herein but are believed to be within a few degrees of the stated endpoints. At temperatures above 200° C. the liquid crystal degrades completely and irreversibly. Preferably, an operating range is 0° C. to 90° C.

Liquid crystal in its native state is an oil which will not dry. Therefore, liquid crystal is provided encapsulated in gelatin (or other encapsulant) and suspended in water and/or other diluents. The size of the encapsulated liquid crystal droplets may be modified within limits based on preparation of the solution or suspension as understood by a chemist of ordinary skill in the art. Other solvents may be used, including polar, non-polar and partly polar solvents, including mixtures, but water is common. Liquid crystal solutions obtained from the supplier may be diluted with water as desired, for example in a range of 20:1 to 1:1 parts water to parts liquid crystal solution. Particles of encapsulated liquid crystal have diameters from about 10 μm up to about 20 μm, which in turn delimits the minimum thickness for the layer of liquid crystal.

In order for the color change of the liquid crystal to be visible, an outer protective layer coated over the liquid crystal must be transparent to light in the visible spectrum. It is therefore preferred to use a polymer which is transparent and UV protective so as not to degrade the performance of the underlying liquid crystal layer, which may be compromised by degradation under UV illumination. The protective coating also serves to provide an electrical and thermal insulating effect. Many transparent polymers may be used as a protective coating and can be applied using a variety of methods. Transparent polymers usable for an overcoating include, without limitation, polyethylene, polypropylene, cyclic olefins, polycarbonates, polyvinyl chloride, liquid silicone rubber, and various acrylics. In addition to being sufficiently transparent to allow the liquid crystal color change to be visible over at least some portion of the visible spectrum, the protective layer should be sufficiently thermally insulating to allow the filament to function with external temperature variation. In embodiments, a temperature is controllable by application of energy to the filament, but consistency and uniformity of the color change are impacted by the thermally insulating properties of the protective layer. A thermally insulating polymeric overcoating may be up to about 50 times the thickness of the underlying coated conductive filament or yarn, and the coating may be as thin as 20 microns, limited by the ability to process the fully coated filament or yarn with conventional textile processing for a particular fabric or other application.

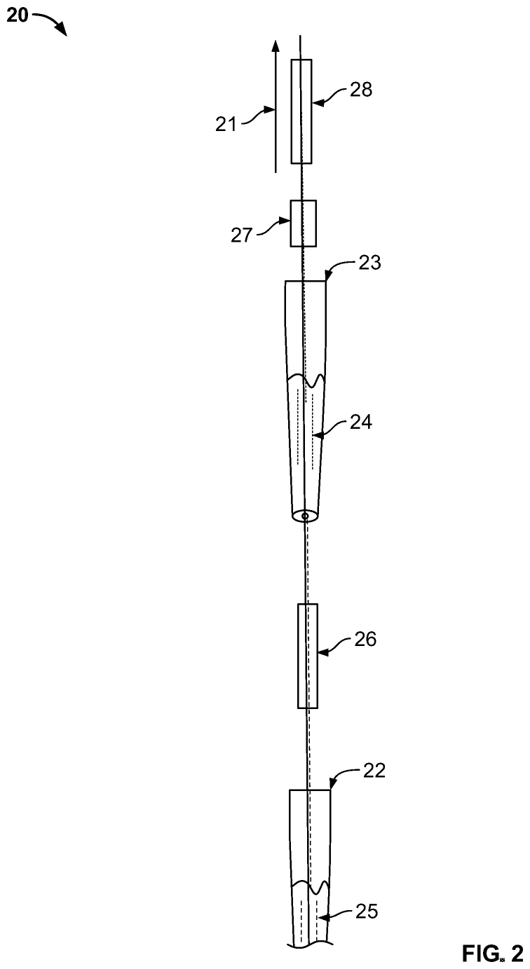

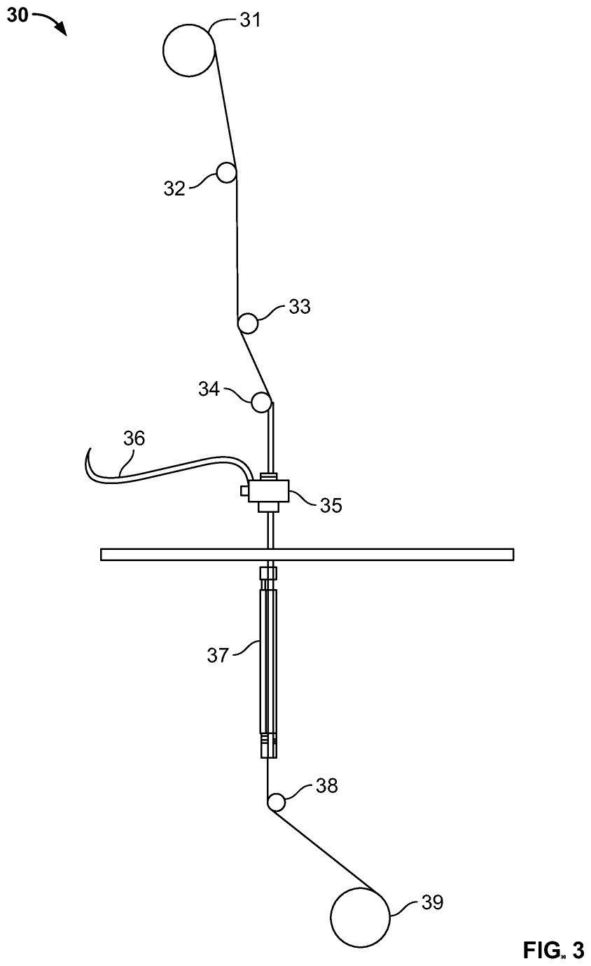

Techniques for making very thin coatings are employed to create the supported color changing filament. An exemplary coating technique described herein is commonly referred to as ‘continuous dip’ a form of free-meniscus coating. FIG. 2 schematically depicts a two-stage free meniscus filament coating line 20, wherein the coating process utilizes coating-head pipettes that have been modified by cutting a Pasteur Pipette and heating to close one end of the pipette to create the necessary orifice size to allow the wire to pass through. Wire passes in an upward direction indicated by arrow 21 through the pipettes 22, 23 from a spool (not shown) at the base of the line and comes into contact with coating solutions that have been syringed into the inverted wide opening of each pipette. Minimizing the hole at the base of each coating-head ensures that no coating solution is lost through drippage. Pulling the conductive filament vertically up through the black backing coating layer stage 25 and liquid crystal coating stage 24, which stages may be arranged in-line in a free-meniscus coating system, has been found to be advantageous to provide appropriately thin coatings. For the polymeric overcoat on the other hand, the coated filament may travel downward in a more conventional wire coating method step as shown in FIG. 3. Heaters/dryers 26, 28, or corona discharge treatment 27, or other treatment apparatuses, may be provided after and/or between the coating stages to dry the black backing layer and/or the liquid crystal layer before coating with a subsequent layer.

A device according to embodiments of the invention includes a source of electric current providing current to individual filaments or yarns in a woven fabric. The color changing filament may be operatively connected to the source of electric current by any contact means known in the art, including soldering, ultrasonic bonding, adhesive paste, and the like. In embodiments, multiple filaments may make contact with the source of electric current through a bussing structure at the edge of the fabric. The filaments may also be inductively heated with an induction coil so that direct contact with a current source is not required. As noted above, each color changing filament in the fabric comprises a resistive conductive filament; a black backing layer coated on the conductive filament; a chiral-nematic liquid crystal layer coated on the black backing layer; and a transparent protective layer coated on the liquid crystal layer; and the finished filament is adapted to be woven by conventional textile means. A controller operatively connected to the source of electric current controls a color change of the fabric over at least a portion of the visible spectrum. A feedback loop monitoring the temperature of the filaments can be used to maintain the current and therefore the temperature within the bandwidth of the desired color. In embodiments, the fabric is adapted to change colors over the entire visible spectrum, from violet to red.

A power source is required to provide temperature change to the color changing filament in a device. Where electric current is used, embodiments may include inductive heating, for example (which would avoid the need for contacts). In the embodiments shown, an electric current may be provided with minimal amperage to obtain color change. For a 38-gauge stainless steel wire, 0.04 amperes was operable to induce color change. The amperage requirement varies with the length of the wire, which in this case was about 20-40 feet on a spool. A very thin filament (on the order of microns) would of course require significantly less amperage. Thus, an operable range of current that a power source may provide for the filaments disclosed herein may be as small as 0.001 amperes. A current above 1 ampere would be undesirable in most settings.

As used herein, “about” in combination with a number has the meaning that would be ascribed to the term by a person of ordinary skill in the art. Alternatively, “about” may be mean within 50% of the stated value.

Several feet of color changing filament were prepared in a free-meniscus coating apparatus, using 38 gauge stainless steel wire. The wire-coating line depicted in the Figures fed the wire through a dual coating in line process having two separate modified pipettes, one containing black acrylic ink coating solution having a low viscosity and the second pipette was supplied with a solution prepared from a liquid crystal from LCR Hallcrest diluted with water. The wire is pulled from an attached spool and through a pipette at a constant rate. Manufacturing coating pipettes shown in the Figures involves cutting a Pasteur Pipette and heating it in a propane torch flame to close one end of the pipette to create the necessary orifice size to run the wire through. Acrylic ink in an aqueous solution was used to apply the black backing layer to a thickness less than 25 μm. The diameter of the inlet hole for the wire at the base of the pipette is variable, and has the capability of determining the thickness of the applied product. This coating method is a preferred method for coating the wire. For some of the samples, following application of the black backing layer, a corona treatment device shown in the Figures was used to treat the acrylic coated wire before applying a layer of the thermochromic liquid crystal. The corona treatment may lower the surface energy of the coating allowing the “active layer” to adhere to the wire and minimizing “beading up.” After drying the wire coated with black backing, a liquid crystal solution from LCR Hallcrest was diluted with water at a ratio of 5 parts liquid crystal to 1 part water and coated on the wire to manufacture a small spool of coated filament. FIG. 3 schematically depicts an overcoating apparatus 30 for applying the protective overcoating. Filament is provided from feed spool over guide and tension pullies 32, 33, 34 to a polymer applicator stage 35 supplied by polymer feed 36. To apply a transparent polymer protective layer to the liquid crystal coated filament, an applicator was prepared as shown in the Figures by fastening the pipet into a 45 degree glass applicator. A test chamber was then formed using ring clamps to hold the applicator as well as a glass tee above a UV curing chamber. The wire was then threaded down through the applicator, tee, and curing chamber 37 over guide pulley 38 and attached to a spool 39 placed on the motor below the chamber. Starting the watercooler and UV light, the lamp was allowed to warm up for ten minutes. Nitrogen was then injected through the glass tee as well as through the tube at the bottom of the curing chamber. Plastic tubing was then attached to the UV Curable Resin syringe, and subsequently threaded down the tubing into the 45 degree applicator. (In embodiments, UV curing polymers may be avoided because liquid crystal is sensitive to UV radiation.) The wire line was started at about 7 feet per minute (FPM), and resin was added to the applicator, making sure not to overfill. The filament was dried with in-line heaters as it is processed through different stages to complete the filament. Direct current at 32 V and 0.04 A was applied to the completed filament and controllable, virtually instantaneous color change from light brown/red to a deep purple was observed.

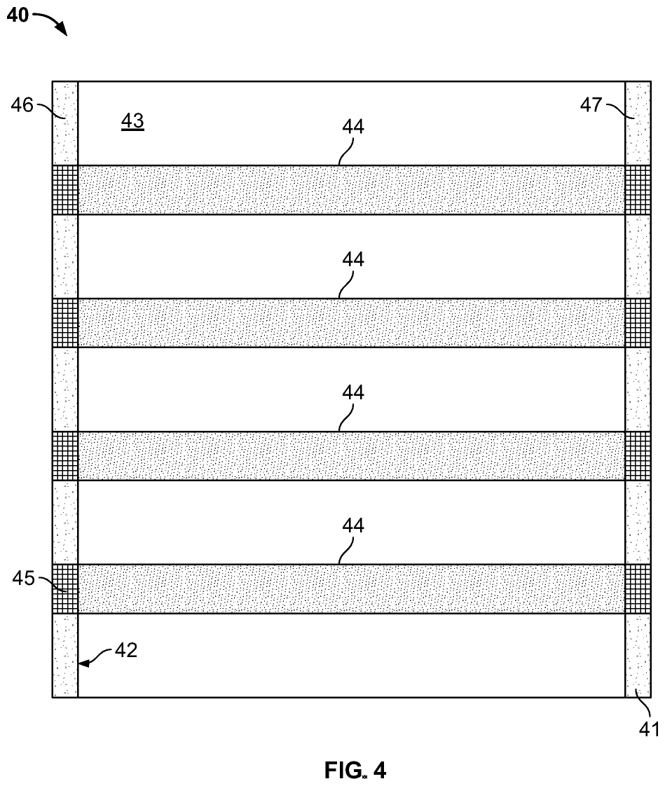

FIG. 4 schematically depicts a color changing textile panel 40 that was produced using filament according to the invention by weaving the filaments on a loom. The fabric comprised a white nylon warp 43 and copper wire in the warp of selvage edges 46 and 47 forming electrical connections 45 with woven copper wire positive and negative terminals 41, 42. Weft elements with the color change filaments were introduced into the fabric at intervals, as described below.

A woven example of color changing fabric 7 ½ inches wide and 6 inches long was produced. The fabric construction was 64 epi (ends per inch) of Nylon 66 multifilament yarns in the warp direction. The yarn is designated as 4/70/17 (twisted 4 turns per inch, 70 filaments per bundle, 17 denier/filament). The weft direction was composed of 28 picks per inch, (ppi) of the same multifilament yarn used in the warp direction with color changing yarns inserted in the weft every 0.75 inch forming a 0.312 inch wide band, (or horizontal stripe.) This pattern was repeated in the weft direction 4 times creating 4 bands, each 0.312 inches wide and transverse to the warp direction. The fabric's weave structures provide stability and ample exposure of the color changing yarn. There are two different weave structures employed. The bands of the color changing yarn have an eight-shaft weft satin weave structure. It allows the yarn to float over seven warp ends and is tacked down by the eighth end. The exposure is about ⅛ inch of the color changing yarn, before it is tacked down by a warp end. This allows the color change yarn bands to be exposed on the face of the fabric in order to effectively see the change in color. The bands using white weft nylon (in between the color changing bands) are woven with tabby weave. The ¼ inch wide selvage edges of the fabric were composed of 16 epi, 34 gauge copper wire which served to mechanically interlock with the color changing yarns in the weft. The color changing yarns were stripped on the ends (¼ inch long stripped ends) of protective thermoplastic cladding so that the electrical connection could be made in the selvage. The ¼ inch copper selvage on each side serves as an electrical bus to connect the positive and negative leads of a power supply which is used to resistively heat the color changing yarns. Once energized, each color changing yarns forming all of the bands in the fabric will change color simultaneously. In this example an electric power supply was connected to the fabric by using alligator clips on each selvedge edge (any polarity). The power supply was adjusted from zero volts DC to 5 volts DC with current set to 1 Ampere. The color changing yarn bands in the fabric all changed from initial grey color through green and remaining blue. When the electrical energy was turned lower the color changing segments of the fabric could be changed from blue to green and remain green. When the voltage was lowered to zero the color changing yarns returned to a grey color.

It will be appreciated that the color change from blue to green to gray may be expanded to display more colors using liquid crystal formulas that are better tailored to the room-atmosphere in which the sample is being used. The filaments may also be bundled and twisted into a yarn and woven into the weft to provide redundancy. A system for bussing current to the weft elements may be adapted from U.S. Pat. No. 10,665,730, which is incorporated by reference. A direct current power source in the form of one or more button cell(s) may be connected to leads of the color changing filaments to form panel sections that change color and even to provide for individually addressable color changing filaments.

The description of the foregoing preferred embodiments is not to be considered as limiting the invention, which is defined according to the appended claims. The person of ordinary skill in the art, relying on the foregoing disclosure, may practice variants of the embodiments described without departing from the scope of the invention claimed. A feature or dependent claim limitation described in connection with one embodiment or independent claim may be adapted for use with another embodiment or independent claim, without departing from the scope of the invention.

What is claimed is:

1. A color-changing filament comprising,
a conductive core adapted to be connected to a source of electric current;
a black backing layer coated on the conductive core;
a liquid crystal layer coated on the black backing layer;
a transparent protective layer coated on the liquid crystal layer.

2. The color-changing filament according to claim 1, wherein the color-changing filament has a thickness less than 1.27 mm, adapted to be taken up on a spool and woven.

3. The color changing filament according to claim 1, wherein the color changing filament has a thickness of less than 100 μm.

4. The color changing filament according to claim 1, wherein the liquid crystal consists of chiral nematic liquid crystal configured to change color over at least a full visible spectrum of violet to red.

5. The color-changing filament according to claim 1, wherein the conductive core is a resistive metal adapted to change temperature in a range of about Δ1° C. to about Δ20° C.

6. The color-changing filament according to claim 1, wherein the black backing layer comprises an acrylic polymer.

7. The color changing filament according to claim 1, wherein the black backing layer comprises an acrylic ink.

8. A color-changing filament, comprising:
a resistive conductive filament adapted to be connected to a source of electric current;
a black backing layer coated on the conductive filament;
a chiral-nematic liquid crystal layer coated on the black backing layer; and
a transparent protective layer coated on the liquid crystal layer.

9. The color-changing filament according to claim 8, wherein
the resistive conductive filament is metallic, having a thickness in a range of 0.0254 mm to 1.27 mm;
the black backing layer comprises an acrylic polymer having a thickness in a range of 5 μm to 20 μm;
the chiral-nematic liquid crystal has a thickness in a range of 10 μm to 100 μm; and
the transparent protective layer comprises at least one polymer layer that is curable by energy that is other than UV radiation.

10. The color-changing filament according to claim 9, wherein the chiral-nematic liquid crystal layer is coated as a plurality of liquid crystal sublayers.

11. The color-changing filament according to claim 9, comprising an adhesive agent to increase bonding of the liquid crystal to the acrylic polymer of the backing layer.

12. The color-changing filament according to claim 8, wherein the yarn achieves color change in a wavelength range of about 450 nm to about 750 nm in a temperature range of A60° C. or less.

13. The color-changing filament of according to claim 8, wherein an interface between the black backing layer is characterized by a reduced surface tension preventing beading of the liquid crystal layer.

14. A method for making a color-changing filament, comprising:
providing a liquid black backing coating composition to a free meniscus coating apparatus;
drawing a flexible resistive conductive filament through the coating apparatus to coat the resistive conductive filament with at least one layer of the black backing composition;
providing a liquid crystal composition with a predetermined viscosity to the free meniscus coating apparatus;
drawing the conductive filament coated with the black backing composition through the coating apparatus to coat the filament with the black backing composition thereon with at least one liquid crystal layer to form a liquid crystal coated filament;
coating the liquid crystal coated filament with a transparent protective polymer to form a color changing filament; and
collecting the color changing filament on a spool.

15. The method according to claim 14, wherein the flexible resistive conductive element is transported vertically up through in-line stages applying the black backing composition and liquid crystal composition and is transported down for coating with transparent protective polymer.

16. The method according to claim 14, comprising treating the conductive filament prior to coating with the black backing composition to improve adherence of the black backing composition; and treating the filament coated with the black backing coating composition to improve adherence with the liquid crystal.

17. The method according to claim 14, wherein the liquid crystal is an aqueous composition and comprising and maintaining the viscosity of the liquid crystal aqueous composition in a range of about 0.15 cP to about 10,000 cP.

18. The method according to claim 14, wherein the resistive conductive filament is a metallic wire or carbon fiber adapted to be resistively heated by passage of electric current to achieve temperature change in a range of Δ60° C. or less cycled repeatedly supporting a predetermined color change without damaging the wire or carbon fiber.

19. The method according to claim 18, wherein the resistive conductive filament is to be resistively heated by passage of electric current to achieve temperature change in a range of Δ1° C. to Δ10° C.

20. The method according to claim 18, wherein the liquid crystal is selected to exhibit color change over a full color spectrum when subjected to said temperature range.

21. A color-change device, comprising:
a source of electric current;
a woven fabric, said fabric comprising a color-changing filament operatively connected to said source of electric current,
said color changing yarn comprising a resistive conductive filament; a black backing layer coated on the conductive filament; a chiral-nematic liquid crystal layer coated on the black backing layer; and a transparent protective layer coated on the liquid crystal layer; and
a controller operatively connected to said source of electric current, said electric current controller controlling a color change of the fabric over a portion of the visible spectrum.

22. The color changing device according to claim 21, wherein the color changes over the entire visible spectrum from red to violet.

23. The color change device according to claim 21, further comprising a Peltier element operatively connected to said filament and to said source of electric current to control a temperature of said liquid crystal in said filament.

24. The color change device according to claim 21, wherein said fabric is made predominantly of said color change filament and edges of said fabric are attached to a plurality of contacts addressing a plurality of said color change yarns in said fabric.
